(19) United States
(12) Patent Application Publication
(10) Pub. No.: US 2004/0105590 A1
(43) Pub. Date: Jun. 3, 2004

(54) Method for still image compressing using filter bank based on non-separable wavelet basis

(76) Inventors: Hiroshi Akimoto, Kawasaki-shi (JP); Anatoly A. Ligun, Dneprozepzhinsk (UA); Vladyslav F. Babenko, Dnepropetrovsk (UA)

Correspondence Address: David L. Garrison, Garrison & Associates PS, Suite 3300, 2001 Sixth Avenue, Seattle, WA, 98121-2522, US

(21) Appl. No.: 10/620,876

(22) Filed: Jul. 15, 2003

Related U.S. Application Data
(60) Provisional application No. 60/396,379, filed on Jul. 16, 2002.

(51) Int. Cl. G06K 9/36; G06K 9/46

(52) U.S. Cl. 382/240; 382/248

(57) ABSTRACT

The present invention describes a method for the compression of still images with the The present invention relates to devices for the processing of images, and in particular for the compression of static images to a high degree and the obtaining of a restored image of high image quality. More specifically, the subject of the present application is a method and mathematical device for the construction of a filter bank for the compression of bi-dimensional static images. A digital filter, based on non-separable wavelet bases, is used to provide effectively compressed images of various dimensions and to give results exceeding currently known standards.

### CROSS-REFERENCE TO RELATED APPLICATION

This application claims the benefit of Provisional Patent Application No. 60/396,379, filed Jul. 16, 2003, entitled “Method for Still Image Compressing Using Filter Bank Based on Non-Separable Wavelet Basis.”

### FIELD OF THE INVENTION

The present invention relates to devices for the processing of images and in particular for the compression of static images to a high degree and the obtaining of a restored image of high image quality. More specifically, the subject of the present invention is the method for construction of a filter bank for the compression of bi-dimensional static images.

The present invention relates generally to image processing techniques, and more particularly to interpolating filter banks based on non-separable wavelet basis for use in processing static images.

### BACKGROUND OF THE INVENTION

Still images are an effective means for describing various subjects. Information about the subject is accumulated in image databases. At the present time a great multitude of types of databases have been developed that are oriented to the applications of special methods of analysis and information processing.

Current digital transmitting systems have a number of advantages for image processing in comparison with analog systems. Recently developed techniques have led to improved methods to reduce image size. Such methods are extremely useful for digital data storing and processing or manipulating. So it may be said that data size reduction is a compression process. As to the architecture, it is possible now to put a complete compression process into a single chip. The main objective of a compression process is to achieve the highest compression ratio and in the same time to provide the minimum data loss that may lead to decompressed image quality degradation.

### SUMMARY OF THE INVENTION

The present invention is better understood upon consideration of following definitions:

arithmetic coder: An entropy coder used to represent the data compactly.

coder: An embodiment of either an encoding or decoding process.

color image: An image that has more than one component. Thus color image used for given invention has three components—Y, Cb, Cr.

discrete wavelet transform (DWT): A wavelet transformation resulting in, spatially discrete coefficients.

encoding process: A process, which takes as its input a source image and outputs compressed image data.

image: A set of two-dimensional arrays of data.

lossless coding: Encoding process in which all of the procedures are lossless.

lossy coding: Encoding process that is not lossless.

quantization: is a process for data volume reducing. So the main purpose is to reduce number of bits for entropy encoding.

Of late there has been significant interest in the compression of video as well as of static images. This was stimulated by the rapid development of information technology, computerization and digital communication technology. In such conditions the image is represented in digital form as a rather large quantity of bits

Compression permits one to significantly decrease the amount of memory necessary for the storage of data and to reduce the time for their transmission (to acceptable rates).

The compressions of images without loss and with losses are distinguished. The first is characterized by insignificant compression coefficients whereas the second ensures much higher degrees of compression. However the problem lies in the search for a compromise between the level of loss upon restoration of the image and the degree of compression of the original image. The higher the degree of compression, the higher the level of loss upon restoration of the image, which, obviously, distracts from the visual quality of the image after decompression. Thus, the image may be described as the graphic form of the presentation of data intended for visual reception. Apart from the visual evaluation of the obtained image, there also exist other criteria, for example, the widespread criterion of PSNR (peak-to-peak signal-to-noise ratio), that determines the relationship of the original image to the restored image after compression, and is calculated thus:

$$PSNR = 10 {log}_{10} \frac{{255}^{2}}{\frac{1}{M \cdot N} {\sum }_{i = 1}^{m} {\sum }_{j = 1}^{n} {( {x}_{ij} - {y}_{ij} )}^{2}} ,$$

where xᵢⱼ is the value of the color or brightness component of the pixel of the initial image with coordinates i, j, and yᵢⱼ is the value of the corresponding color or brightness component of the pixel of the restored image, and M and N are the dimensions of the image.

The values of PSNR were calculated for images restored after use of the given method and were compared with values of PSNR after use of the standard JPEG2000. Comparative data representing images restored after compression with the assistance of the given method and the JPEG2000 standard, and the digital values of PSNR are entered in FIGS. 3-8. In FIG. 3 digital values of PSNR are presented for images in the QCIF format, in FIG. 4 the originals of the images and the images after compression with the JPEG2000 method and with the given method, thus, if the possibility to evaluate the visual quality of the image after application of the given method. In FIG. 5 the digital values of PSNR are entered for images of the SIF format, in FIG. 6-8 the test images themselves are presented, both the originals as well as those obtained after compression with the JPEG2000 method and the given method.

The images restored after compression with the aid of the method that is the subject of this patent are sharper, in them the outlines of the subjects are viewed better.

Moreover, several words must be said about the format of the images with which this method is used. At this time there are several formats for the presentation of images in data transmittal systems, for example RGB and YUV formats. The model known as a combination of the routing of the primary colors “Red, Green and Blue” RGB, is used in many monitors. On a black screen the addition of the three primary colors takes place. The absence of all of these colors lends the black color, while their presence at maximum intensity gives the white color.

YCbCr also is a prevalent format for the presentation of the images, where the color of the pixel is determined by the intensity of each of the components Y, Cb and Cr. Y represents the brightness, Cb and Cr are components of color diversity, whereby Cb is the difference between the intensity values of red and green and Cr is the difference between the intensity values of blue and green. In contemporary image compression methods the YCbCr format is used on the strength of the information content of the Y-component and to a much lesser degree on the strength of the information content of the remaining components. In the given invention the translation of the image from RGB into YUV format is presented in this way:

$$\begin{matrix}Y = \frac{1}{23} ( 7 R + 2 B + 14 G ) ; \\ Cb = - \frac{4}{23} ( R - 3 B + 2 G ) ; \\ Cr = \frac{4}{69} ( 8 R - B - 7 G ) .\end{matrix}$$

Any image located in a computer is numbered and stored as a bitmap, that is, a matrix in which each element describes the color of a point on the image. To store the bitmap in such a form is undesirable due to the large quantity of computer memory required. The image consists of elements called pixels. For different formats of presentation of images, a pixel may contain a different number of bits. The presented method works with images in which a pixel contains 24 bits (bmp format).

Moreover, there are different formats for the dimensions of frames during video transmittal. The most widespread of them are R601, SIF, and QCIF. The measurement of the frame in R601 format is 720×480 pixels, SIF is 352×240 pixels, and QCIF is 176×144. The encoder that is the subject of this patent operates with all image formats.

Previously, for the compression of still images a discrete-cosine transformer (JPEG standard) was used.

The discrete-cosine transformer was applied to the matrix of the image. The result of the transformation is such a matrix of coefficients for which coefficients with low values may be disregarded (that is, made null). To obtain the initial image, reverse transformation is used. It is possible to present the work of the JPEG standard in several stages, described briefly below.

First a conversion of the image is made from the RGB color field to the YUV color field.

In the next step after the transformation the image is divided into square portions measuring 8×8 pixels. After this, a discrete-cosine transformation (DCT) is made on each portion. An analysis of each block, its decomposition into the component colors, and a subtotal of the frequency of the appearance of each color is thereby made.

Thus, during transformation we obtain a matrix in which many coefficients are either close to or equal to zero. Moreover, owing to the imperfection of human vision, one can approximate the coefficients more roughly without a noticeable loss of image quality.

For this, the quantization of coefficients is used. During this, a part of the information is lost, but larger compression coefficients may be obtained.

However, with the passage of time the JPEG2000 standard, based on the coding of still images with the help of wavelet decomposition, appeared. The JPEG2000 standard also operates with color images, one of the important aspects here is the decorrelation of three-color components, in order that there may be the possibility of restoring the color component separately from the other components. Several words about the work of the JPEG2000 algorithm:

Several levels of wavelet-decomposition are applied to the image. These levels contain coefficients separated into sub-ranges, each level of decomposition consists of four sub-ranges: one approximating (containing low frequencies) and three detailed (corresponding to high frequency).

The level of decomposition is connected to the subsequent degree of two. That is, the subsequent level of displacement contains half as many coefficients as the preceding, one may say that resolution will be twice as low horizontally as well as vertically. To limit the quantity of stored coefficients, quantization is applied. After quantization supplemental data processing takes place. If the data are stored without quantization, then it is obvious that the image will be restored without a loss of information in relation to the original.

In general, the basic stages of operation of the JPEG2000 algorithm may be presented thus:

The color components of the image are separated, after which the image and its components are subjected to wavelet-transformation. After wavelet-transformation, the frequency coefficients, ordered by sub-ranges, are quantized and gathered in rectangular blocks for encoding. The bit-mapped surfaces of the coefficients in the encoded blocks are encoded with the help of an entropy encoder. The regions of the coefficients that are of interest may be encoded first. Thus, with the help of wavelet-transformation it is possible to obtain a much higher degree of compression.

One of the most essential aspects of use of wavelet-decomposition is the correct choice of wavelet. For the task of image compression discrete wavelets work best of all. Bases on the grounds of uninterrupted wavelets are not orthonormal. Discrete wavelets, on the strength of their orthonormality, usually lead to more precise transformation and the presentation of a signal, and in particular to its reverse transformation after the compression procedure. Because of this they also are better suited for information transfer systems. The discrete wavelet basis succeeds with the assistance of an iterated algorithm with a change of scale and with the displacement of a single function.

In accord with the basic aspect of the present invention, in the given invention for the compression of still images a discrete orthogonal transformation is used.

The wavelet-transformation divides the signal into separate frequency components, which permits the study of each of the components and the receipt, in this way, of good frequency-temporal localization. That is, using the wavelet-spectrum of a signal there is the possibility of obtaining not only certain information about the frequency components of the signal (in the present case—of the image), but also to indicate their location on the temporal axis. This consists of the advantage of the wavelet-transformation in comparison with, for example, the Fourier transformation, which does not give information about the place where the signal frequency changed.

After the execution of the wavelet transformation it is necessary to compress the obtained data, discarding any non-essential part of the encoded information. This is done with the help of the quantization procedure, which will be examined in detail below. Such a procedure leads to substantial reduction in the necessary computer memory and the demands during the transfer of information, which is the basic goal of image compression.

The process of restoration of an images proceeds in the reverse order. A detailed description and the attached drawings will help to more fully understand the essence of the present invention.

### BRIEF DESCRIPTION OF THE DRAWINGS

FIG. 1 shows a basic image encoding scheme.

FIG. 2 depicts a frequency allocation after the first level of wavelet transform.

FIG. 3 illustrates PSNR values for pictures restored after compressing by JPEG2000 and given method.

FIG. 4 illustrates visual quality of images compressed by JPEG2000 and given method (QCIF format).

FIG. 5 illustrates PSNR values for pictures restored after compressing by JPEG2000 and given method (SIF format).

FIG. 6 illustrates visual quality of images compressed by JPEG2000 and given method (QCIF format).

FIGS. 9-1, 9-2 depict filtering coefficients for the first wavelet decomposition level.

FIGS. 10-1, 10-2 depict filtering coefficients for the second wavelet decomposition level.

FIGS. 11-1, 11-2 depict filtering coefficients for the third wavelet decomposition level.

### DETAILED DESCRIPTION

Direct and reverse wavelet-transformation is calculated by means of calculation of signal packets with the function designated by the aggregate of values of coefficients at points of quantization. Taking into consideration the statistical peculiarities of the majority of signals (useful information distributed in the low-frequency range of the signal's spectrum, and interference/noise in the high-frequency range), the signal is transformed with the use of two complementary filters—both low frequency and high-frequency.

The examined wavelets relate to the class that implements quadrature mirror filters. Their peculiarity is the fact that the high-frequency filter is obtained from the corresponding low-frequency filter by its simple transposition in the reverse order and a change of the sign (even or odd). Thus the wavelet isolates local peculiarities of the signal (image) in each point, and thus is a high-frequency filter, while the corresponding low-frequency filter is described by a scaling function. Since said method is based in a two-dimensional discrete wavelet transformation, then the high- and low-frequency filters corresponding to it are matrices. The matrix notation is, in the given case, the most appropriate method, allowing one to effectively execute the wavelet-decomposition.

Algorithms on the basis of the wavelet-transformation as well as on the basis of DCT consist of three steps:

1. a de-correlated transformation;

2. a quantization procedure;

3. entropic encoding.

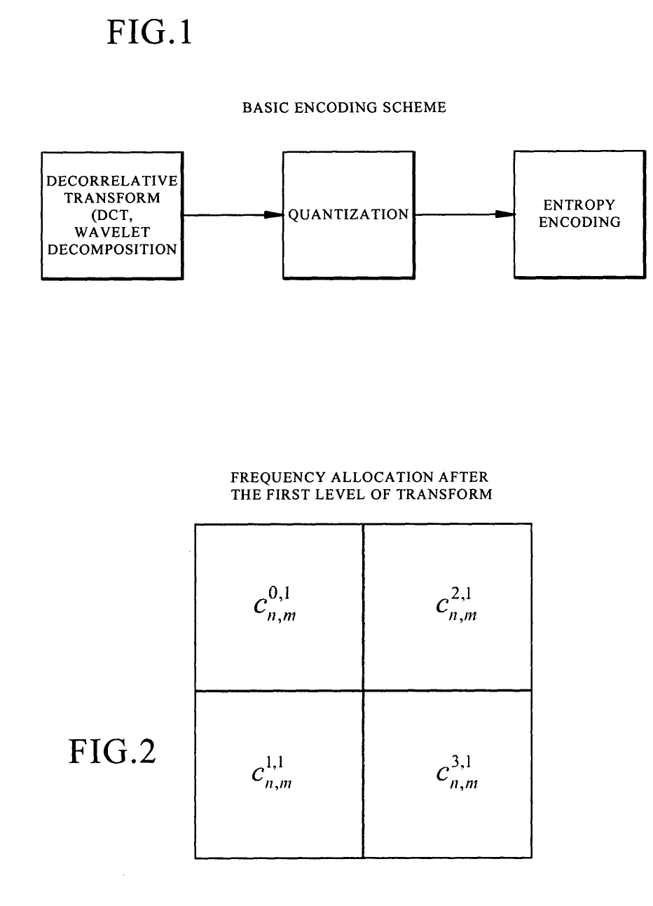

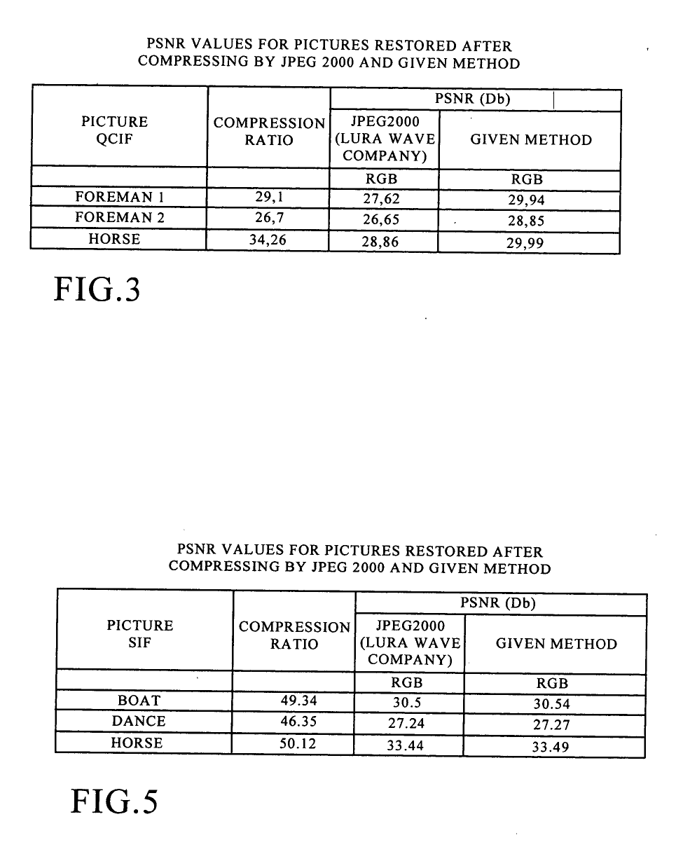

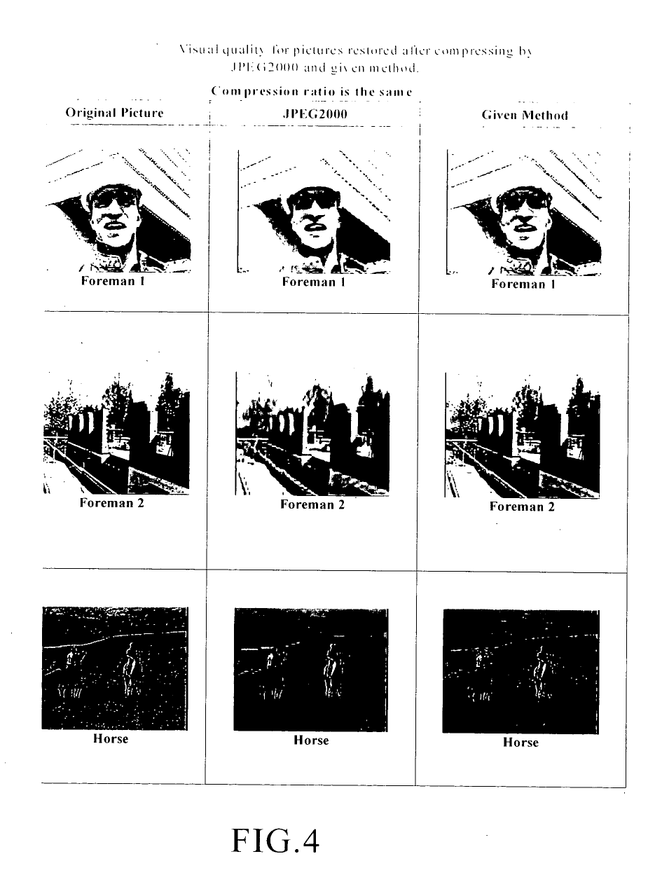

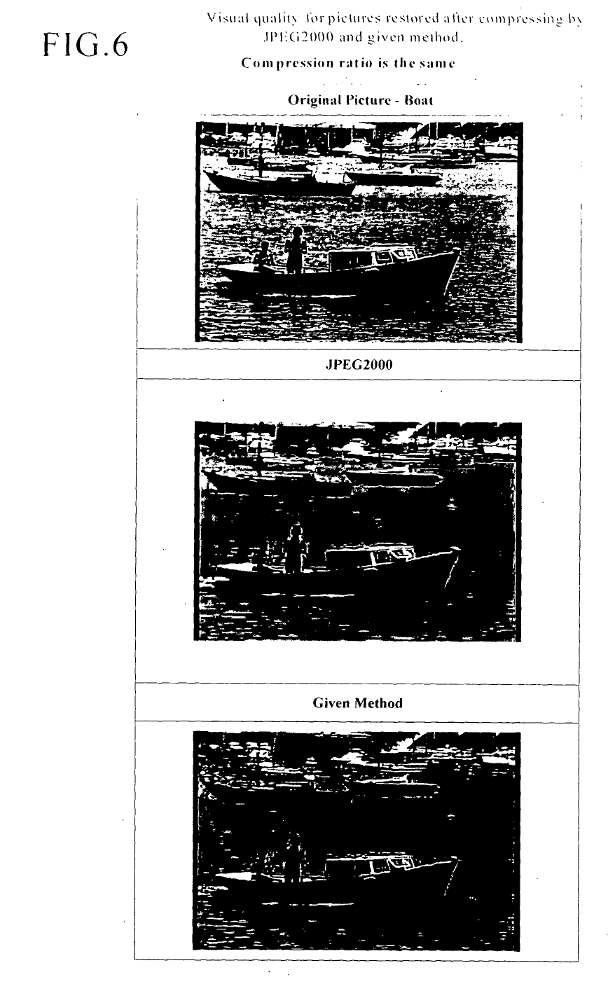

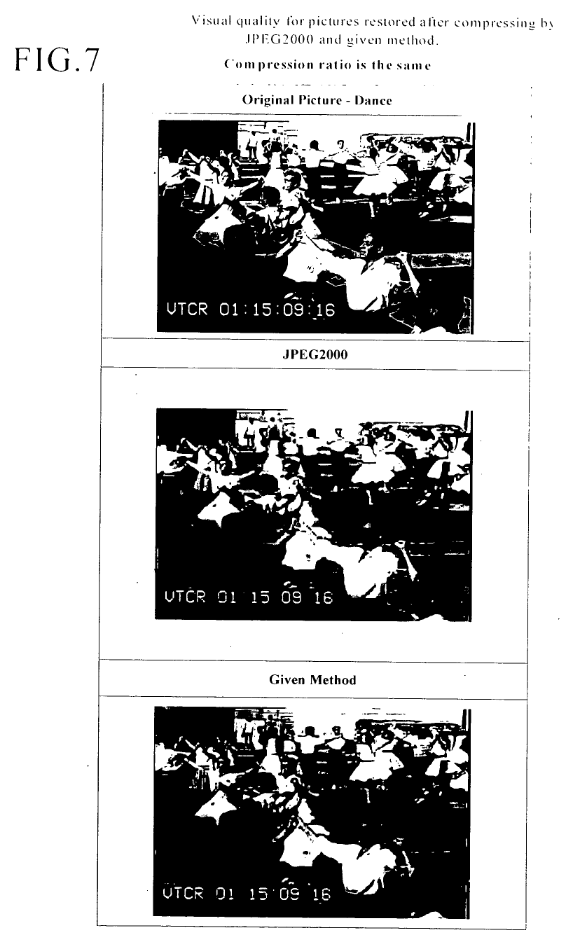

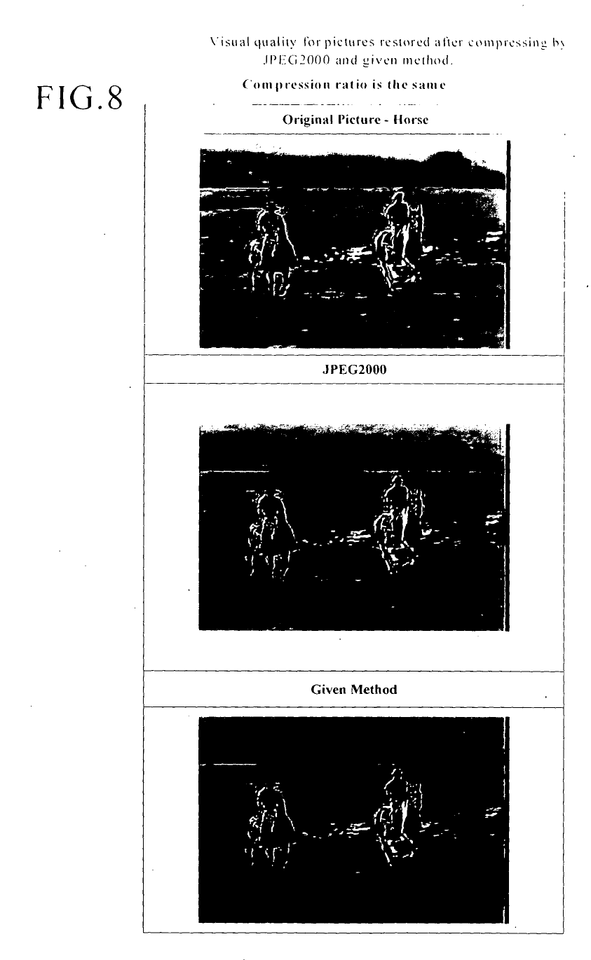

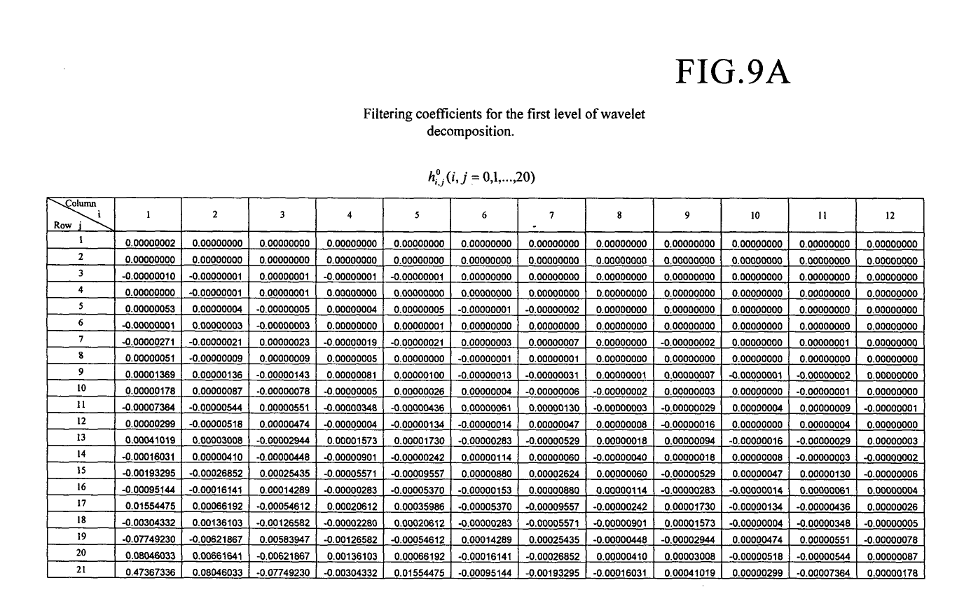

The general plan for image encoding is presented in FIG. 1.

The choice of wavelet basis for the encoding of data suitable for wavelet-transformation is one of the most difficult tasks. Therefore, in each case experiments are made to satisfy the following criteria for wavelet evaluation:

1. evenness;

2. accuracy of approximation;

3. size of the region of measurement;

4. frequency selectivity of the filter.

When observing the given criteria it is necessary to take into consideration the requirements presented against the final result. Depending on the task given, the properties of the wavelets may be considered in different ways. For example, if the restored image should not be substantially distinguished from the original, then in that case the compression will be poor. A strong compression is necessary, for example, during transmission of information on channels with limited bandwidth. In the present invention wavelets are gathered which meet the criteria suitable for the strong compression of images.

The separable basis is the simplest type of wavelet basis for images. The use of the separable basis is traditional for contemporary codes. Nonetheless, non-separable bases may be more effective.

A basic aspect of the present invention is the use of a non-separable wavelet basis for the coding of still images. On the whole contemporary methods for the compression of still images with losses are based on filters constructed with the help of wavelet bases. As a rule, they are based on the use of one-dimensional wavelets—the use of the scheme of S. Mallat, or a tensor product of one-dimensional methods. The basis of these methods is the cascade algorithm DWT, which is based on a decomposition formula (direct method)

$${c}_{k}^{j} = {\sum }_{n ∈ Z} {c}_{n}^{j + 1} {\overline{h}}_{n - 2 k} , \qquad {d}_{k}^{j} = {\sum }_{n ∈ Z} {c}_{n}^{j + 1} {\overline{g}}_{n - 2 k} , \qquad ( {g}_{n} = {( - 1 )}^{1 - n} {\overline{h}}_{1 - n} )$$

and a reconstruction formula (reverse method)

$${c}_{k}^{j + 1} = {\sum }_{n ∈ Z} {c}_{n}^{j} {h}_{k - 2 n} + {\sum }_{n ∈ Z} {d}_{n}^{j} {g}_{k - 2 n} .$$

The quality of algorithms based on wavelet bases depends substantially on the choice of coefficients hₙ of the filtering mask.

In accord with the fundamental aspect of the present invention a new digital filter is proposed, based on non-separable wavelet bases.

In accord with another aspect of the present invention the corresponding algorithm DWT is presented, which permits one to construct methods for the compression of images of different dimensions, with a degree of compression exceeding the existing methods.

Filters H₀, H₁, H₂ are constructed for the three steps of the decomposition. The coefficients

$${H}_{k} = {\{ {h}_{i , j}^{k} \}}_{i , j = - 21}^{21}$$

(k=0,1,2) for the filters are symmetrical. This property may be presented thus:

h_{i,j}^{k}=h_{i,1-j}^{k},h_{i,j}^{k}=h_{1-i,j}^{k},h_{i,j}^{k}=h_{1-i,1-j}^{k}.

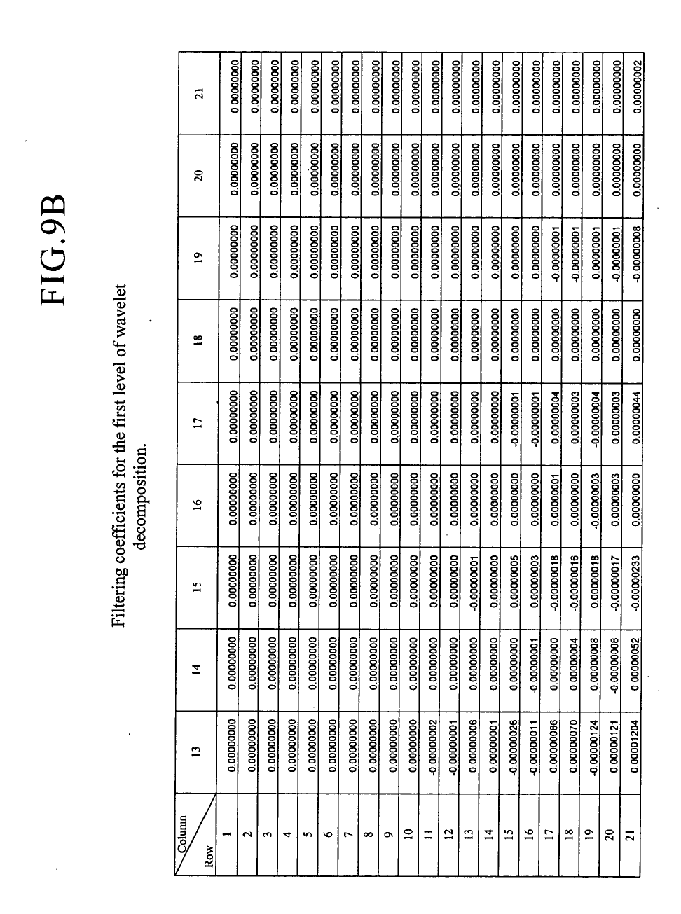

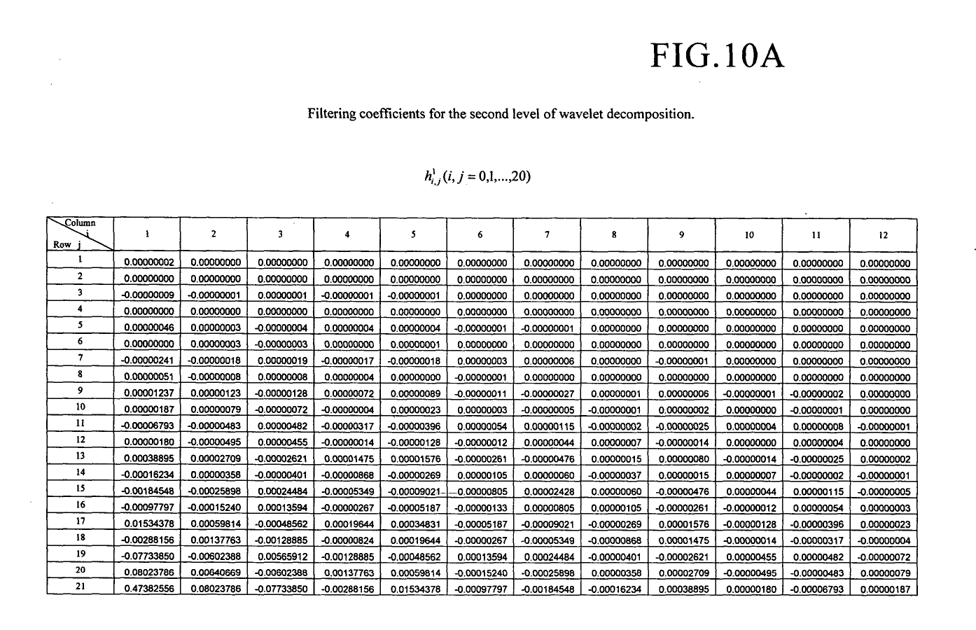

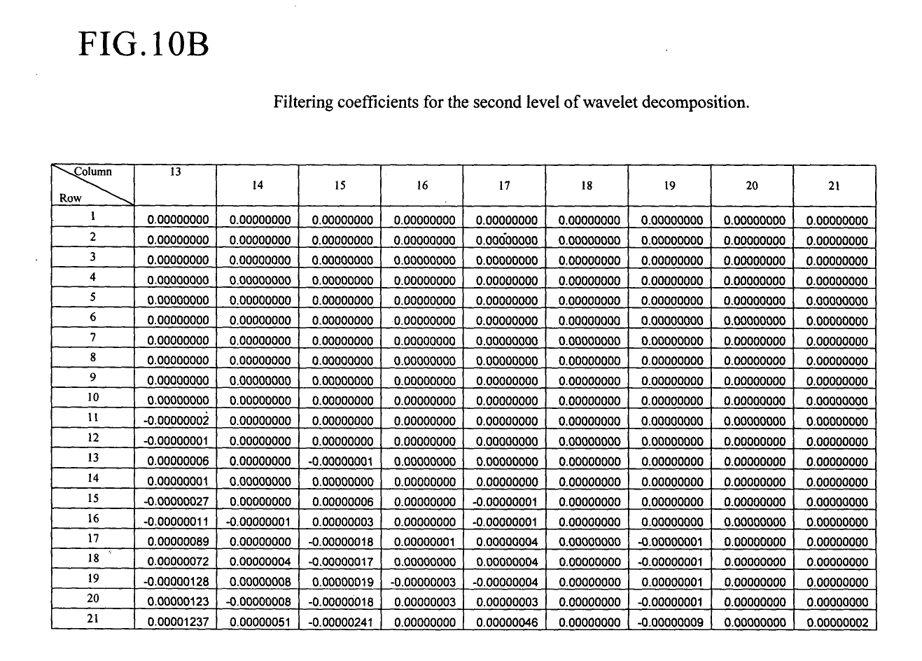

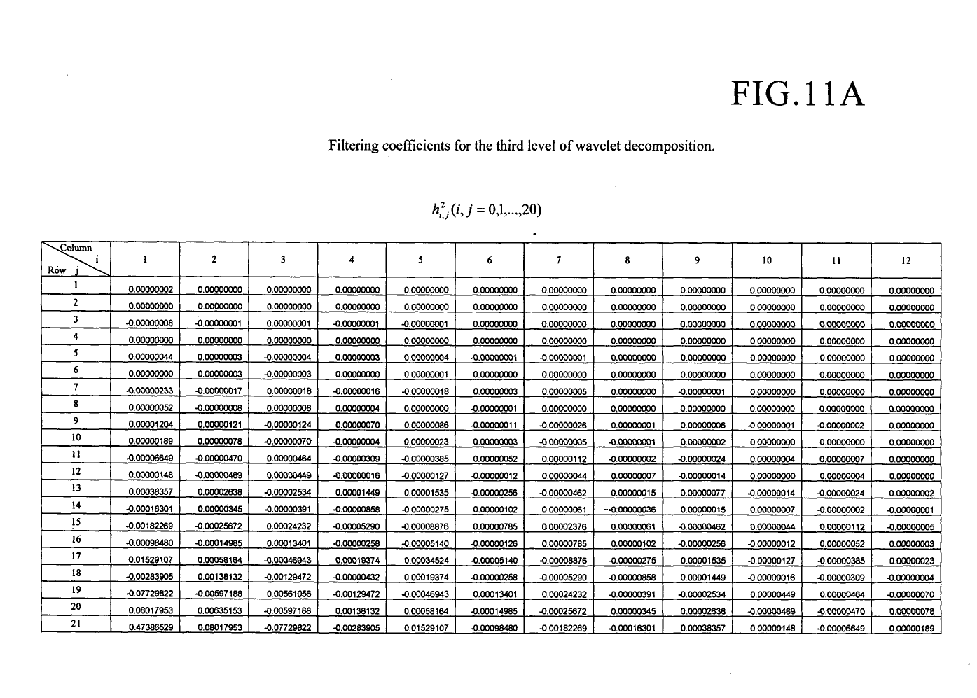

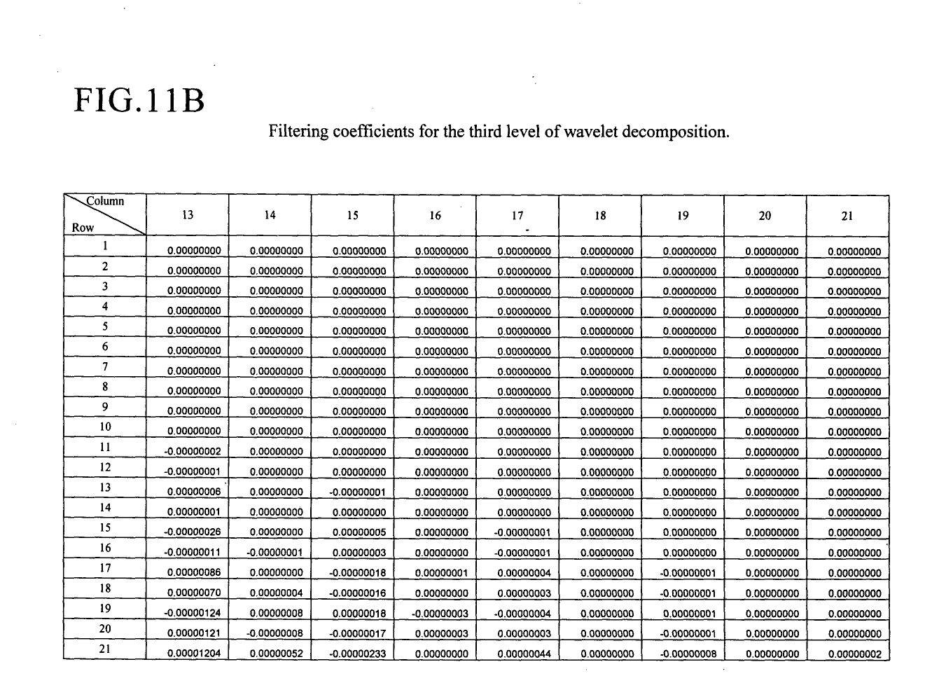

In FIGS. 9-1 and 9-2 the coefficients h_{i,j}⁰ (i, j=0,1, . . . ,20) are entered in tables, in FIGS. 10-1, 10-2 the coefficients h_{i,j}¹ (i, j=0,1, . . . ,20) are entered in a table and the coefficients h_{i,j}² (i, j=0,1, . . . ,20) are entered in tables in FIGS. 11-1 and 11-2. On the strength of the symmetry, if h_{i,j}^{k} are known for i,j=0,1, . . . , 20, k=0,1,2, then the remaining coefficients are determined unambiguously.

The filter H₀ is used in the transition from the null (pixel level) to the first level of separation of frequency, the filter H₁ is used for the transition from the first to the second level and the filter H₂ for the transition from the second to the third level.

For the separation of frequency for each level on the basis of the obtained masks of filters an array of filters is constructed according to the following rules

$$\begin{matrix}{G}^{k , 1} = \{ {g}_{n , m}^{k , 1} \} , where {g}_{n , m}^{k , 1} = {( - 1 )}^{m} {h}_{n - 1 , m}^{k} , \\ {G}^{k , 2} = \{ {g}_{n , m}^{k , 2} \} , where {g}_{n , m}^{k , 2} = {( - 1 )}^{n} {h}_{n , m}^{k} , \\ {G}^{k , 3} = \{ {g}_{n , m}^{k , 3} \} , where {g}_{n , m}^{k , 3} = {( - 1 )}^{n + m} {h}_{n - 1 , m}^{k} .\end{matrix}$$

We shall describe the use of the indicated filters. Through

$${c}_{i , j}^{0 , 0}$$

the initial value of the color component for the pixel is designated with the number (i,j).

Using the mask of coefficients h_{i,j}⁰ image filtration is conducted on the lower

$${c}_{n , m}^{0 , 1} ,$$

the middle

$${c}_{n , m}^{1 , 1} , {c}_{n , m}^{2 , 1}$$

and the higher

$${c}_{n , m}^{3 , 1}$$

frequencies in accord with the decomposition formulas:

$${c}_{n , m}^{0 , 1} = {\sum }_{i , j} {c}_{i , j}^{0 , 0} {h}_{i - 2 n , j - 2 m}^{0} , {c}_{n , m}^{k , 1} = {\sum }_{i , j} {c}_{i , j}^{0 , 0} {g}_{i - 2 n , j - 2 m}^{0 , k} , ( k = 1 , 2 , 3 ) .$$

As a result, the filtered upper and lower frequencies of the image displaced into the corresponding four sub-ranges are obtained. The distribution of the obtained frequencies after the first level of transformation is indicated in FIG. 2.

For the panel of values

$${c}_{n , m}^{0 , 1}$$

the same decomposition formulas are applied, but the filter the filter H₁ is used in place of the filter H_{0,}, filter G^{1,1} is used in place of filter G^{0,1}, filter G^{1,2} is used in place of filter G^{0,2}, and filter G^{1,3} is used in place of filter G^{0,3}:

$${c}_{n , m}^{0 , 2} = {\sum }_{i , j} {c}_{i , j}^{0 , 1} {h}_{i - 2 n , j - 2 m}^{1} , {c}_{n , m}^{k , 2} = {\sum }_{i , j} {c}_{i , j}^{0 , 1} {g}_{i - 2 n , j - 2 m}^{1 , k} , ( k = 1 , 2 , 3 ) .$$

Similarly, decomposition formulas are used for the panels of middle and high frequencies.

After this procedure, the decomposition formulas are used again, but with the masks H₂, G^{2,1}, G^{2,2}, G^{2,3}. As a result, 64 panels of coefficients are obtained.

The fragment of pseudocode for the corresponding decomposition calculation are shown below:

```
for(y=0;y<Y;y++)
  for(x=0;x<X;x++)
  {
    s0=s1=s2=s3=0;
    for(j=0;j<J;j++)
      for(i=0;i<I;i++)
      {
        s0+=c(i,j)*h(i−2*x,j−2*y);
        s1+=(−1)^{j}*c(i,j)*h(i−1−2*x,j−2*y);
        s2+=(−1)ⁱ*c(i,j)*h(i−2*x,j−2*y);
        s3+=(−1)^{i+j}*c(i,j)*h(i−1−2*x,j−2*y);
      }
    w[0]=s0;
    w[1]=s1;
    w[2]=s2;
    w[3]=s3;
  }
```

Further all coefficients are put into descending order and after the choice of the given quantity of coefficients, (which is determined by the degree of compression), all remaining data are quantized according to a linear scale. Pre-quantized coefficients are designated with y_{q}=Q[y], where Q[●] is the quantization operator. Under quantization in the present invention a non-linear operation is understood, which leads to a reduction in the volume of the transferred data and, correspondingly, to a loss of information. In the present method a scalar quantization is used, in which each element from the set of coefficients y is quantized individually. The scalar quantization converts the intervals from real numbers └qᵢ^{k}, qᵢ₊₁^{k}) to real numbers. Thus,

$${y}_{q} [ k ] = \frac{1}{2} ( {q}_{i}^{k} + {q}_{i + 1}^{k} )$$

is obtained for all y[k], satisfying the condition qᵢ^{k}≦y[k]<qᵢ₊₁^{k}, where i is the level of quantization, k is the quantization step.

Further the quantized values are coded by the RLE method and the arithmetic coding method.

After the application of scalar quantization, the group compression method and the arithmetic coding method we obtain a data file.

For the restoration of the encoded image reconstruction formulas are used. For the given values

$${c}_{n , m}^{0 , 3} , {c}_{n , m}^{1 , 3} , {c}_{n , m}^{2 , 3} , {c}_{n , m}^{3 , 3}$$

calculate

$${c}_{n , m}^{0 , 2}$$

according to the rule:

$${c}_{n , m}^{0 , 2} = {\sum }_{i , j} {c}_{i , j}^{0 , 3} {h}_{n - 2 i , m - 2 j}^{3} + {\sum }_{p = 1}^{3} {\sum }_{i , j} {c}_{i , j}^{p , 3} {g}_{n - 2 i , m - 2 j}^{p , 3} ( k = 1 , 2 , 3 ) , \\ similarly we find {c}_{n , m}^{0 , 1}$$

$${c}_{n , m}^{0 , 1} = {\sum }_{i , j} {c}_{i , j}^{0 , 2} {h}_{n - 2 i , m - 2 j}^{2} + {\sum }_{p = 1}^{3} {\sum }_{i , j} {c}_{i , j}^{p , 2} {g}_{n - 2 i , m - 2 j}^{p , 2} ( k = 1 , 2 , 3 ) , \\ and {c}_{n , m}^{0 , 0}$$

$${c}_{n , m}^{0 , 0} = {\sum }_{i , j} {c}_{i , j}^{0 , 1} {h}_{n - 2 i , m - 2 j}^{1} + {\sum }_{p = 1}^{3} {\sum }_{i , j} {c}_{i , j}^{p , 1} {g}_{n - 2 i , m - 2 j}^{p , 1} ( k = 1 , 2 , 3 ) . \\ Similarly , we find the values {c}_{n , m}^{1 , 2} , {c}_{n , m}^{2 , 2} , {c}_{n , m}^{3 , 2} et al .$$

The fragment of pseudocode for the corresponding reconstruction calculation are shown below:

```
for(y=0;y<Y;y++)
  for(x=0;x<X;x++)
  {
    s=0;
    for(j=0;j<J;j++)
      for(i=0;i<I;i++)
      {
        s+=w[0]*h(x−2i,y−2i);
        s+=w[1]*(−1)^{j}*h(x−1−2i,y−2j);
        s+=w[2]*(−1)ⁱ*h(x−2*i,y−2*j);
        s+=w[3]*(−1)^{i+j}*h(x−1−2*i,y−2*j);
      }
  }
```

To reduce the influence of the border the image continues evenly from the left and upper edges and connects at the opposite edge. Further, the image is transformed from RGB to YCbCr according to the formulas

$$\begin{matrix}Y = \frac{1}{23} ( 7 R + 2 B + 14 G ) ; \\ Cb = - \frac{4}{23} ( R - 3 B + 2 G ) ; \\ Cr = \frac{4}{69} ( 8 R - B - 7 G ) .\end{matrix}$$

After the restoration of the components YCbCr at the null level (the pixel level) the color range is transformed into the RGB palette.

$$\begin{matrix}R = Y + \frac{3}{2} Cr ; \\ G = Y - \frac{1}{4} ( Cb + 3 Cr ) ; \\ B = Y + \frac{7}{4} Cb .\end{matrix}$$

### INDUSTRIAL APPLICABILITY

The current invention discloses methods and procedures for still image compressing using filter bank based on non-separable wavelet basis. The methods and procedures disclosed in the current application can be executed or preformed in a computer, other microprocessors, programmable electronic devices or other electronic circuitry that are used for encoding images. They can be loaded into the above devices as software, hardware, or firmware. They can be implemented and programmed as discrete operations or as a part of a larger image compression strategy.

Thus, the present invention describes a method for the compression of still images with the assistance of non-separable wavelet bases. In compliance with the statute, the invention has been described in language more or less specific as to structural features. It is to be understood, however, that the invention is not limited to the specific features shown or described, since the means and construction shown or described comprise preferred forms of putting the invention into effect. Additionally, while this invention is described in terms of being used to provide a method for compression of still images, it will be readily apparent to those skilled in the art that the invention can be adapted to other uses as well. The invention should not be construed as being limited to still image compression and is therefore, claimed in any of its forms or modifications within the legitimate and valid scope of the appended claims, appropriately interpreted in accordance with the doctrine of equivalents.

What is claimed is:

1. A method for compressing still images that are stored in electronic media comprising the step of:
a. selecting the image to be compressed;
b. selecting the desired degree of compression;
c. constructing filters, based on the desired degree of compression and physical characteristics of the image, for decomposition of the image by non-seperablen wavelet transformation
d. transforming the image into an array of frequency coefficients of the pixels by executing one level of decomposition for each of the three filters;
e. quantizing the values of the frequency coefficients; and
f. encoding the quantized values by run length and arithmetic coding methods; whereby the image is restored in the YCbCr format through the use of a pre-designated reconstruction formula; and transformed into the RGB palette after reconstruction is complete.
